(19) United States
(12) Patent Application Publication
(10) Pub. No.: US 2021/0261232 A1
(43) Pub. Date: Aug. 26, 2021

(54) SYSTEM AND METHOD OF FABRICATING SANDWICH PANELS WITH A FOAMABLE MATERIAL

(71) Applicant: The Boeing Company, Chicago, IL (US)

(72) Inventors: Gary E. Georgeson, Tacoma, WA (US); Xiaoxi Wang, Mukilteo, WA (US)

(21) Appl. No.: 16/796,365

(22) Filed: Feb. 20, 2020

(51) Int. Cl. B64C 1/12; B32B 5/18; B29C 70/30

(52) U.S. Cl. CPC B64C 1/12; B32B 5/18; B29L 2031/3076; B32B 2605/18; B32B 2607/00; B29C 70/30

(57) ABSTRACT

Fabrication system and associated methods of fabricating a sandwich panel. In one embodiment, a method includes holding a first skin and a second skin of the sandwich panel with a gap between opposing faces of the first skin and the second skin, and expanding a foamable material between the first skin and the second skin to form a foam core of the sandwich panel.

### FIELD

This disclosure relates to the field of fabrication, and more particularly, to fabricating sandwich panels.

### BACKGROUND

A sandwich panel (also referred to as a composite sandwich panel) is a composite structure having a low-density core sandwiched between two sheets of material. Sandwich panels have a high strength-to-weight ratio, which makes them useful in a variety of applications, such as aerospace. Due to the usefulness of sandwich panels as structural elements, it is desirable to identify ways of efficiently and effectively fabricating the sandwich panels.

### SUMMARY

Provided herein are a fabrication system and associated methods for fabricating sandwich panels. As an overview, the core of a sandwich panel is formed during assembly or fabrication of the sandwich panel. Previously, fabrication of a sandwich panel involved fabricating the skins and the core separately, and then attaching the skins to the core to form the sandwich panel. In the embodiments described herein, the core of the sandwich panel is formed during fabrication using a foamable material. The foamable material (in an unexpanded state) is inserted or loaded between the skins, and expands between the skins to form a foam core for the sandwich panel. Thus, the foam core of the sandwich panel is formed during fabrication instead of being pre-fabricated. This is beneficial as the process used to form a sandwich panel is more efficient.

One embodiment comprises a method of fabricating a sandwich panel. The method comprises holding a first skin and a second skin of the sandwich panel with a gap between opposing faces of the first skin and the second skin, and expanding a foamable material between the first skin and the second skin to form a foam core of the sandwich panel.

In another embodiment, the method further comprises applying an adhesive on the opposing faces of the first skin and the second skin prior to expanding the foamable material.

In another embodiment, the method further comprises inserting the foamable material in the gap between the first skin and the second skin.

In another embodiment, the method further comprises cutting excess portions of the foam core that project from ends of the first skin and the second skin.

In another embodiment, expanding the foamable material comprises activating the foamable material with heat.

In another embodiment, the first skin and the second skin are formed from a metal material.

In another embodiment, the first skin and the second skin are formed from a cured composite material.

In another embodiment, the first skin and the second skin are formed from pre-impregnated composite fibers, and expanding the foamable material comprises activating the foamable material with heat, where the heat also cures the first skin and the second skin.

In another embodiment, the foamable material comprises foamable pellets.

In another embodiment, the foamable material comprises at least one foamable sheet.

In another embodiment, the sandwich panel is manufactured for an aircraft.

Another embodiment comprises a method of fabricating a sandwich panel. The method comprises laying up pre-impregnated composite fibers for a first skin of the sandwich panel on a first tool member, and laying up pre-impregnated composite fibers for a second skin of the sandwich panel on a second tool member. The method further comprises loading a foamable material on the second skin, and holding the first skin and the second skin with a gap between opposing faces of the first skin and the second skin. The method further comprises applying heat to expand the foamable material between the first skin and the second skin to form a foam core of the sandwich panel, and to cure the first skin and the second skin.

In another embodiment, applying heat comprises inserting the first tool member and the second tool member in an autoclave.

Another embodiment comprises a fabrication system configured to form a sandwich panel. The fabrication system comprises a forming tool having a first tool member configured to hold a first skin of the sandwich panel, and a second tool member configured to hold a second skin of the sandwich panel with a gap between opposing faces of the first skin and the second skin. The fabrication system further includes an activator configured to activate a foamable material between the first skin and the second skin to expand to form a foam core of the sandwich panel.

In another embodiment, the activator comprises an autoclave.

In another embodiment, the fabrication system further comprises an applicator configured to insert the foamable material in the gap between the first skin and the second skin.

In another embodiment, the fabrication system further comprises an applicator configured to apply an adhesive on the opposing faces of the first skin and the second skin prior to expanding the foamable material.

The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments of the present invention are now described, by way of example only, with reference to the accompanying drawings. The same reference number represents the same element or the same type of element on all drawings.

FIG. 1 is a perspective view of a sandwich panel in an illustrative embodiment.

FIG. 2 is a schematic diagram of a fabrication system in an illustrative embodiment.

FIG. 3 is a flow chart illustrating a method of fabricating a sandwich panel in an illustrative embodiment.

FIG. 4 is a side view of tool members securing skins in an illustrative embodiment.

FIG. 5 is a side view of a foamable material expanded to form a foam core in an illustrative embodiment.

FIG. 6 is a side view of a sandwich panel in an illustrative embodiment.

FIG. 7 is a flow chart illustrating a method of fabricating a sandwich panel in another illustrative embodiment.

FIG. 8 is a side view of tool members securing skins in an illustrative embodiment.

FIG. 9 is a side view of an adhesive applied to skins in an illustrative embodiment.

FIGS. 10-11 are side views of a foamable material inserted between skins in illustrative embodiments.

FIG. 12 is a side view of a foamable material expanded to form a foam core in an illustrative embodiment.

FIG. 13 illustrates a sandwich panel removed from a forming tool in an illustrative embodiment.

FIG. 14 is a flow chart illustrating a method of fabricating a sandwich panel in another illustrative embodiment.

FIG. 15 is a side view of skins placed on tool members in an illustrative embodiment.

FIG. 16 is a side view of an adhesive applied to skins in an illustrative embodiment.

FIGS. 17-18 are side views of a foamable material loaded onto a skin in illustrative embodiments.

FIG. 19 is a side view of tool members securing skins in an illustrative embodiment.

FIG. 20 is a side view of a foamable material expanded to form a foam core in an illustrative embodiment.

FIG. 21 is a flow chart illustrating a method of fabricating a sandwich panel in another illustrative embodiment.

FIG. 22 is a side view of skins laid up on tool members in an illustrative embodiment.

FIGS. 23-24 are side views of a foamable material loaded onto a skin in illustrative embodiments.

FIG. 25 is a side view of tool members securing skins in an illustrative embodiment.

FIG. 26 is a side view of a foamable material expanded to form a foam core in an illustrative embodiment.

FIG. 27 is a side view of a sandwich panel with interlayers in an illustrative embodiment.

FIG. 28 is a side view of tool members securing skins in an illustrative embodiment.

FIG. 29 is a side view of tool members securing skins in an illustrative embodiment.

FIG. 30 is a flow chart illustrating an aircraft manufacturing and service method in an illustrative embodiment.

FIG. 31 is a schematic diagram of an aircraft in an illustrative embodiment

### DETAILED DESCRIPTION

The figures and the following description illustrate specific exemplary embodiments. It will be appreciated that those skilled in the art will be able to devise various arrangements that, although not explicitly described or shown herein, embody the principles described herein and are included within the contemplated scope of the claims that follow this description. Furthermore, any examples described herein are intended to aid in understanding the principles of the disclosure, and are to be construed as being without limitation. As a result, this disclosure is not limited to the specific embodiments or examples described below, but by the claims and their equivalents.

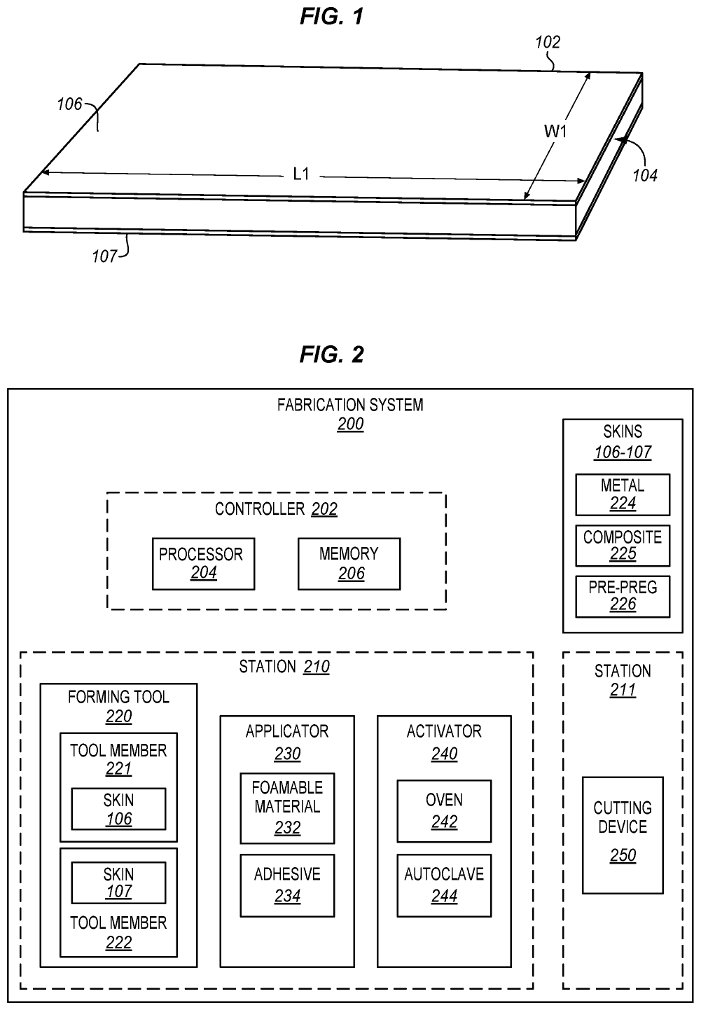

FIG. 1 is a perspective view of a sandwich panel 102 in an illustrative embodiment. A sandwich panel 102 generally includes a foam core 104 (e.g., a low-density core) sandwiched between skins 106-107 (also referred to as face sheets) that are bonded to opposing sides of the foam core 104. Skins 106-107 may be formed from materials having high tensile and compression strength, such as metal materials (e.g., Titanium, Aluminum, steel, etc.), composite materials (e.g., Carbon Fiber Reinforced Polymer (CFRP), Carbon Fiber Reinforced Plastic (CRP), Carbon Fiber Reinforced Thermoplastic (CFRTP), etc.), fiberglass, etc. Skins 106-107 may be solid sheets of material as shown in FIG. 1 that are generally flat. Each of skins 106-107 has a dimension indicated by a width (W1) and a length (L1). Foam core 104 is a filling between skins 106-107. In this embodiment, foam core 104 is formed from a foamable material that expands during fabrication as will be described in further detail below. Sandwich panel 102 may be used as a structural element for a variety of applications, such as for aircraft, watercraft, automobiles, etc.

FIG. 2 is a schematic diagram of a fabrication system 200 in an illustrative embodiment. Fabrication system 200 is configured to form one or more sandwich panels 102, such as shown in FIG. 1. Fabrication system 200 includes a controller 202 that is configured to manage the operations for one or more stations 210-211. Controller 202 may be implemented on a hardware platform comprised of a processor 204 that executes instructions stored in memory 206 as shown in FIG. 2. A processor 204 comprises an integrated hardware circuit configured to execute instructions, and memory 206 is a non-transitory computer readable storage medium for data, instructions, applications, etc., and is accessible by processor 204. Although not shown in FIG. 2, controller 202 may be implemented on a hardware platform comprised of analog circuitry, digital circuitry, or a combination of the two.

Stations 210-211 represent various stages of fabricating a sandwich panel 102, and may include a variety of fabrication equipment. Tasks performed at stations 210-211 may be automated, may be manual, or may be a combination of automated tasks and manual tasks. In this embodiment, station 210 includes a forming tool 220 that includes tool members 221-222. Tool members 221-222 are configured hold or secure a skin 106-107 during fabrication. For example, tool members 221-222 may include gripping members, robotic arms, jaws, suction devices, magnetic devices, or the like that act to hold a skin 106-107 during fabrication. Tool members 221-222 may also include one or more support plates that maintain a position and/or shape of a skin 106-107 during fabrication. As described above, skins 106-107 may be comprised of a variety of materials. For example, skins 106-107 may be formed from a stiff or rigid material, such as a metal material 224, a (cured) composite material 225, etc. In another example, skins 106-107 may be formed from a non-rigid material, such as pre-impregnated composite fibers (referred to as a pre-preg 226), which are composite fibers impregnated with a thermoplastic or thermoset resin.

Tool member 221 is configured to hold or secure a first skin (e.g., skin 106) of sandwich panel 102, while tool member 222 is configured to hold or secure a second skin (e.g., skin 107) of sandwich panel 102. Tool members 221-222 are configured to hold these skins 106-107 with a gap between opposing faces of the skins 106-107, which allows for the foam core 104 to be formed between skins 106-107. Although two tool members 221-222 are shown in FIG. 2, forming tool 220 may include more tool members 221-222.

Station 210 may also include an applicator 230 that is configured to insert, apply, or load materials on or between skins 106-107. For example, applicator 230 may include a robotic arm, a blower, rollers, or another type of machine. In one embodiment, applicator 230 is configured to insert or load a foamable material 232 on or between skins 106-107. A foamable material 232 comprises a material that begins in an unexpanded state, and expands, enlarges, swells, etc., in response to a stimulus or trigger condition. For example, the foamable material 232 may comprise foamable pellets, beads, powder, etc., that is configured to expand in volume, such as when heated to a predetermined temperature. Foamable pellets may comprise a thermoplastic material, a thermosetting material, and/or any other suitable polymer material, and a foaming agent. The foaming agent, when heated to at least a predetermined temperature, forms a plurality of holes, pockets, or voids within the material of the foamable pellets so that the volume of the pellets increases. In another example, the foamable material 232 may alternatively comprise foamable sheets that are configured to expand in volume, such as when heated to a predetermined temperature. In another example, the foamable material 232 may be a hybrid of foamable pellets and foamable sheets, or another material.

In another embodiment, applicator 230 is configured to apply an adhesive 234 on one or both of the opposing faces of the skins 106-107. In sandwich panel 102, skins 106-107 are bonded to foam core 104. Thus, adhesive 234 may be applied to form a bond or promote bonding between skin 106 and the foam core 104, and/or between skin 107 and the foam core 104. Adhesive 234 may comprise an epoxy resin, an epoxy film, a paste, a glue, a plastic film, such as a Polyethylene terephthalate or polyester (PET) film, a Polyimide (PI) film, a Polyphenylsulfone (PPSU) film, a Polymethyl methacrylate (PMMA) film, or another type of material.

Station 210 may further include an activator 240 that is configured to activate the foamable material 232 to expand. Activation causes the foamable material 232 to transform from an unexpanded state to an expanded state between skins 106-107. Expansion of the foamable material 232 forms the foam core 104 of sandwich panel 102. One way to activate the foamable material 232 is with heat. Thus, in one embodiment, activator 240 is configured to apply heat to activate the foamable material 232. Activator 240 may include an oven 242, an autoclave 244, or another type of device that applies heat, such as a heat blanket, forced hot air, Ultraviolet (UV) activation, induction heat, Infrared (IR) heating, heating elements within forming tool 220 (e.g., resistive heating), etc. Activator 240 may alternatively initiate a chemical reaction to cause expansion of the foamable material 232. However, there may be other activation agents for foamable material 232 than are not specifically described herein.

In this embodiment, station 211 includes a cutting device 250. With the foamable material 232 expanded between skins 106-107, sandwich panel 102 is formed with the foam core 104 bonded to skins 106-107. Cutting device 250 is configured to trim excess portions of the foam core 104 that project from the ends of sandwich panel 102. Cutting device 250 may also be configured to cut sandwich panel 102 to a desired shape and/or size. Cutting device 250 may include a saw, laser, water jet, etc.

Fabrication system 200 may include other stations and systems used to fabricate sandwich panel 102 that are not shown for the sake of brevity. Also, the configuration of stations 210-211 are shown as an example, and other configurations are considered herein.

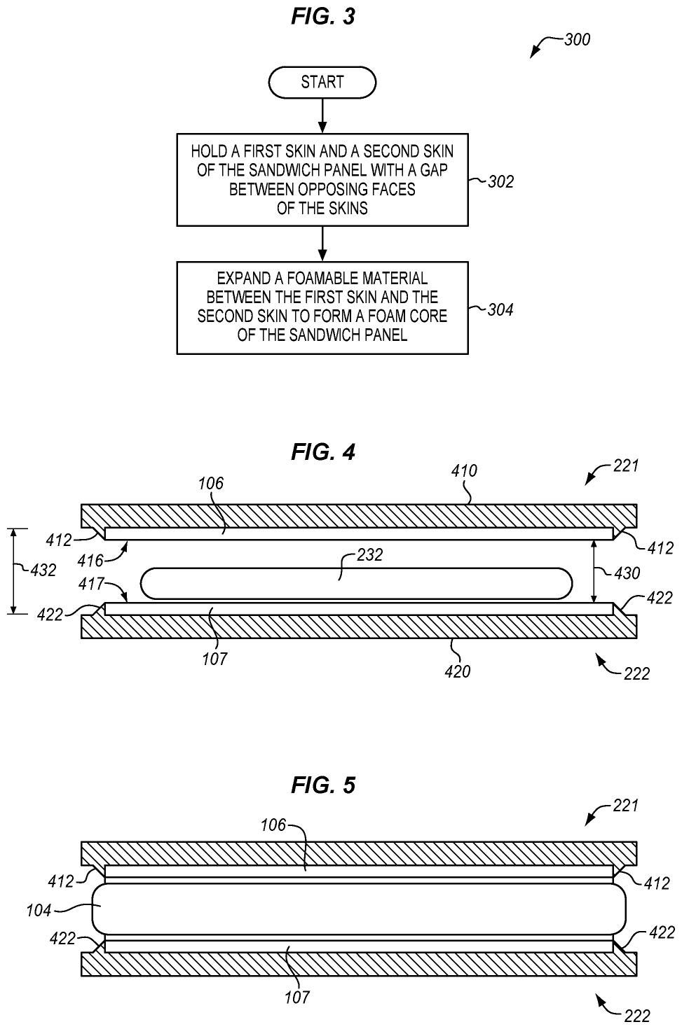

FIG. 3 is a flow chart illustrating a method 300 of fabricating a sandwich panel 102 in an illustrative embodiment. The steps of method 300 will be described with respect to fabrication system 200 of FIG. 2, although one skilled in the art will understand that the methods described herein may be performed by other types of systems. The steps of the methods described herein are not all inclusive and may include other steps not shown. The steps for the flow charts shown herein may also be performed in an alternative order.

For method 300, skin 106 and skin 107 are held or secured with a gap between opposing faces of skin 106 and skin 107 (step 302). As described above, skins 106-107 may be formed from a metal material 224, a (cured) composite material 225, a pre-preg 226, or other type of material. FIG. 4 is a side view of tool members 221-222 securing skins 106-107 in an illustrative embodiment. In this embodiment, tool member 221 includes a support plate 410 and gripping members 412. Support plate 410 is configured to maintain a position and/or shape of skin 106 during fabrication, and gripping members 412 are configured to hold or secure skin 106 on support plate 410. Likewise, tool member 222 includes a support plate 420 and gripping members 422. Support plate 420 is configured to maintain a position and/or shape of skin 107 during fabrication, and gripping members 422 are configured to hold or secure skin 107 on support plate 420. The structure of tool members 221-222 is provided as one example, and tool members 221-222 may have other configurations in other examples.

Tool members 221-222 hold skins 106-107, respectively, with a face 416 (or inner surface) of skin 106 facing an opposing face 417 (or inner surface) of skin 107. Tool members 221-222 may hold skins 106-107 in parallel as shown in FIG. 4. However, skins 106-107 may be held in other orientations so that face 416 of skin 106 is facing an opposing face 417 of skin 107, with a gap 430 between opposing faces 416-417. Gap 430 is set at the desired thickness of the foam core 104 of sandwich panel 102. Thus, the overall thickness 432 of the final sandwich panel 102 is constrained by the distance in which tool members 221-222 separate and hold skins 106-107.

Also shown in FIG. 4 is a foamable material 232 disposed between skin 106 and skin 107. The foamable material 232 is in an unexpanded state at this point in the fabrication process. Thus, the foam core 104 has yet to be fabricated. In FIG. 3, the foamable material 232 is expanded between skin 106 and skin 107 to form the foam core 104 of sandwich panel 102 (step 304). The foamable material 232 may be activated by heat, by a chemical reaction, or by another stimulus or trigger condition to expand between skins 106-107 into an expanded foam. FIG. 5 is a side view of the foamable material 232 expanded to form the foam core 104 in an illustrative embodiment. Through expansion, the foamable material 232 spans the gap 430 between skins 106-107 and bonds to the face 416 of skin 106 and the face 417 of skin 107. Therefore, the expanded foamable material 232 forms the foam core 104 of sandwich panel 102.

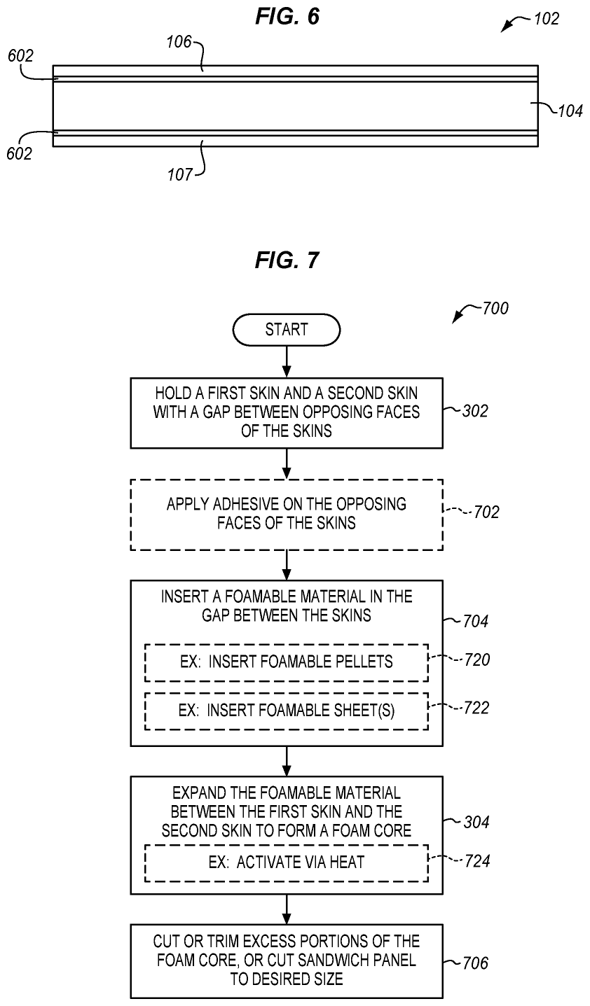

After forming the foam core 104, sandwich panel 102 may be cooled (if heating was used) and removed from forming tool 220. At this point, any excess portions of the foam core 104 may be trimmed or cut. FIG. 6 is a side view of sandwich panel 102 in an illustrative embodiment. Sandwich panel 102 includes the foam core 104 formed from expansion of the foamable material 232. The foam core 104 is bonded to skins 106-107 through bonds 602. The bonds 602 may be formed from an adhesive or the like, a plastic material, through curing of skins 106-107, or through another means as will be described in more detail below.

One technical benefit of method 300 is that the foam core 104 of sandwich panel 102 is generated during assembly of sandwich panel 102, which is more efficient. In prior fabrication methods, a core was machined or otherwise manufactured prior to fabrication of a sandwich panel, and the pre-manufactured core was assembled with the skins. In method 300, the foam core 104 is “grown” from a foamable material 232 during fabrication or assembly of sandwich panel 102, which eliminates an additional process of pre-manufacturing a core. Another technical benefit is that the raw materials (e.g., the foamable material 232) used to fabricate sandwich panel 102 occupy less space, as the foamable materials 232 are in an unexpanded state before fabrication. Yet another technical benefit is that the thickness 432 of sandwich panel 102 can be tightly controlled, as the thickness of the foam core 104 is constrained by the forming tool 220 used to hold the skins 106-107 during fabrication.

The following provides additional details of methods of fabricating sandwich panel 102 in other embodiments. FIG. 7 is a flow chart illustrating a method 700 of fabricating a sandwich panel 102 in another illustrative embodiment. In this embodiment, skins 106-107 are generally stiff or rigid before fabrication. For example, skins 106-107 may be formed from a metal material 224, a (cured) composite material 225, or the like. For method 700, skin 106 and skin 107 are held with a gap between opposing faces 416-417 of skin 106 and skin 107 (step 302). FIG. 8 is a side view of tool members 221-222 securing skins 106-107 in an illustrative embodiment. Tool members 221-222 hold skins 106-107, respectively, with the face 416 of skin 106 facing an opposing face 417 of skin 107. With this configuration, there is a gap 430 between opposing faces 416-417 of skins 106-107. Gap 430 is set at the desired thickness of the foam core 104 of sandwich panel 102. Thus, the overall thickness 432 of the final sandwich panel 102 is constrained by tool members 221-222.

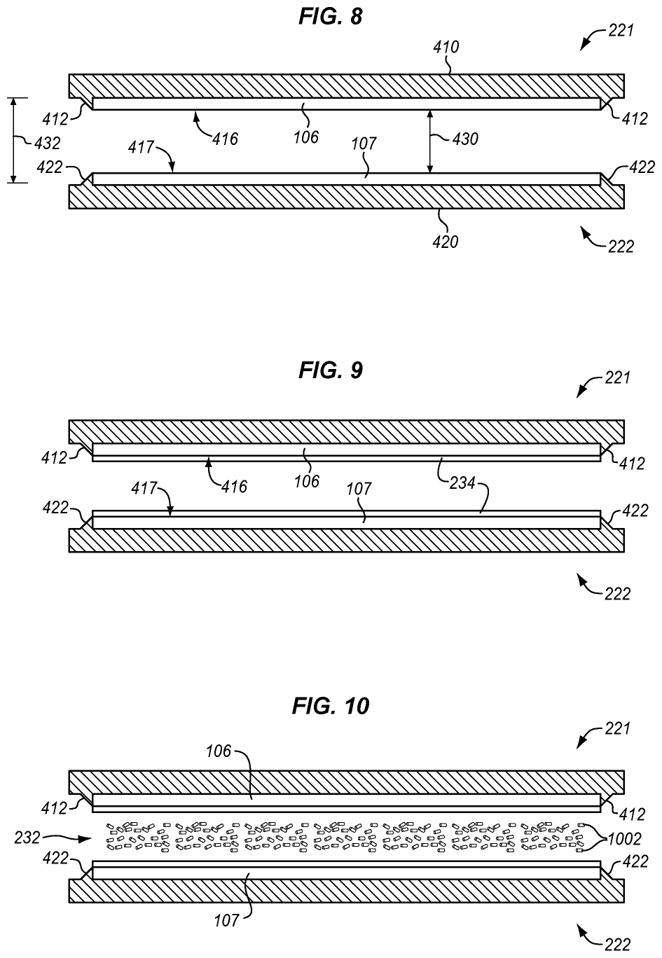

In FIG. 7, an adhesive 234 may be applied on the opposing faces 416-417 of skins 106-107 (optional step 702), such as with applicator 230. FIG. 9 is a side view of an adhesive 234 applied to skins 106-107 in an illustrative embodiment. Adhesive 234 may be applied to the entire surface area of faces 416-417, or to specific portions along the surface area of faces 416-417. Application of adhesive 234 is optional as there may be other ways of bonding the foam core 104 to skins 106-107 during fabrication.

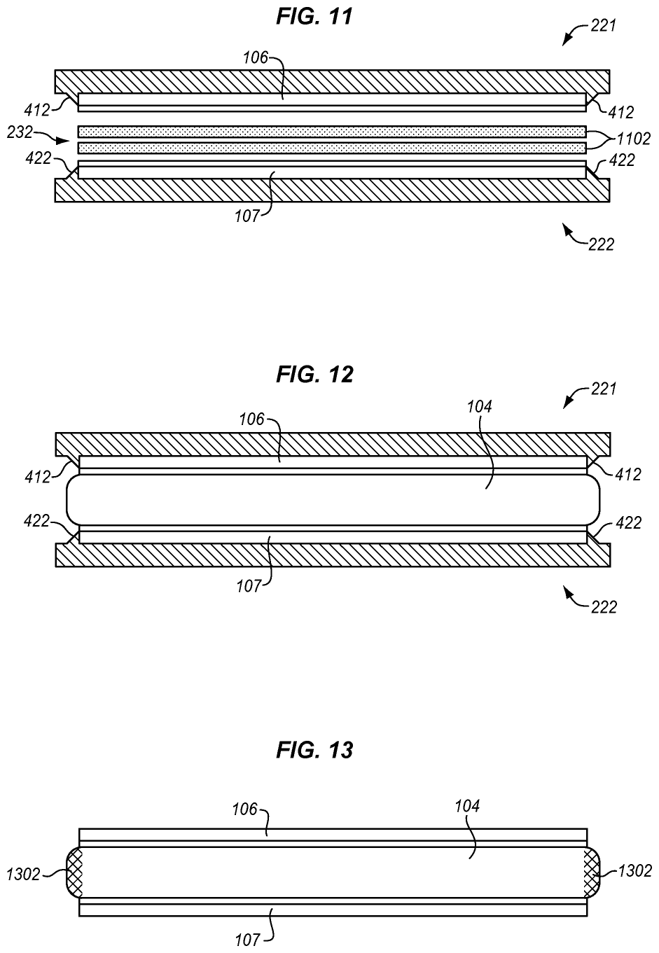

In FIG. 7, a foamable material 232 is inserted, loaded, or otherwise placed in the gap 430 between skins 106-107 (step 704). FIGS. 10-11 are side views of a foamable material 232 inserted between skins 106-107 in illustrative embodiments. As shown in FIG. 10, the foamable material 232 may be comprised of foamable pellets 1002 that are inserted in the gap 430 between skins 106-107 (see optional step 720 in FIG. 7). As shown in FIG. 11, the foamable material 232 may be comprised of one or more foamable sheets 1102 that are inserted in the gap 430 between skins 106-107 (see optional step 722 in FIG. 7). One or more foamable sheets 1102 may be placed or stacked between skins 106-107. In either case, the foamable pellets 1002 or foamable sheets 1102 may be generally distributed uniformly between skins 106-107 to form a consistent foam core 104.

In FIG. 7, with the foamable material 232 (in its unexpanded state) arranged between skins 106-107, the foamable material 232 expands between skins 106-107 (step 304). In one embodiment, the foamable material 232 may be activated by heat (optional step 724) with an oven 242, an autoclave 244, or another heat source to cause expansion. FIG. 12 is a side view of the foamable material 232 expanded to form the foam core 104 in an illustrative embodiment. Through expansion, the foamable material 232 spans the gap 430 between skins 106-107 and bonds to the face 416 of skin 106 and the face 417 of skin 107. Therefore, the expanded foamable material 232 forms the foam core 104 of sandwich panel 102.

After forming the foam core 104, sandwich panel 102 may be cooled (if heating was used) and removed from forming tool 220. FIG. 13 illustrates sandwich panel 102 removed from forming tool 220 in an illustrative embodiment. At this point, some excess portions 1302 of the foam core 104 may project outward from ends of skins 106-107. Thus, the excess portions 1302 of the foam core 104 may be trimmed or cut (step 706 of FIG. 7), such was with cutting device 250. Also, sandwich panel 102 may be cut to a desired shape and/or size in step 706. Method 700 therefore forms a sandwich panel 102, such as shown in FIG. 6.

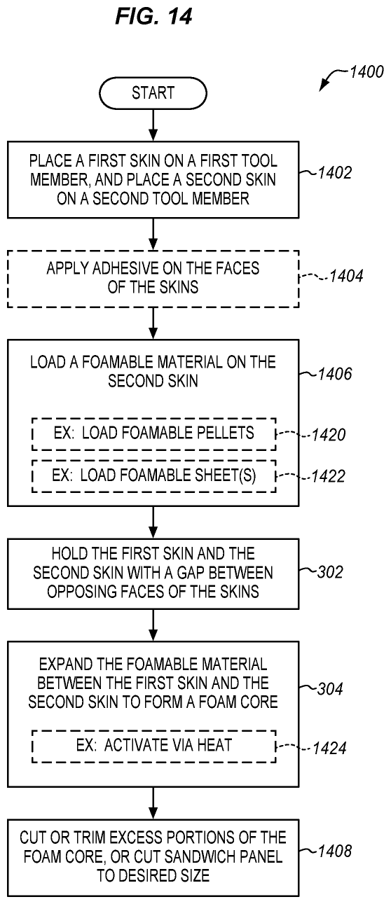

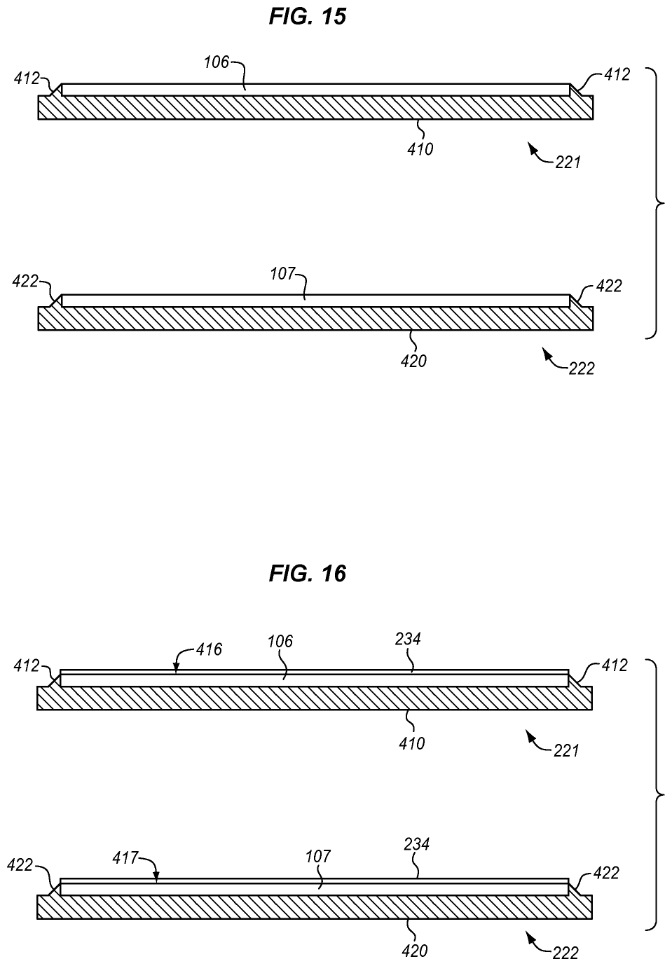

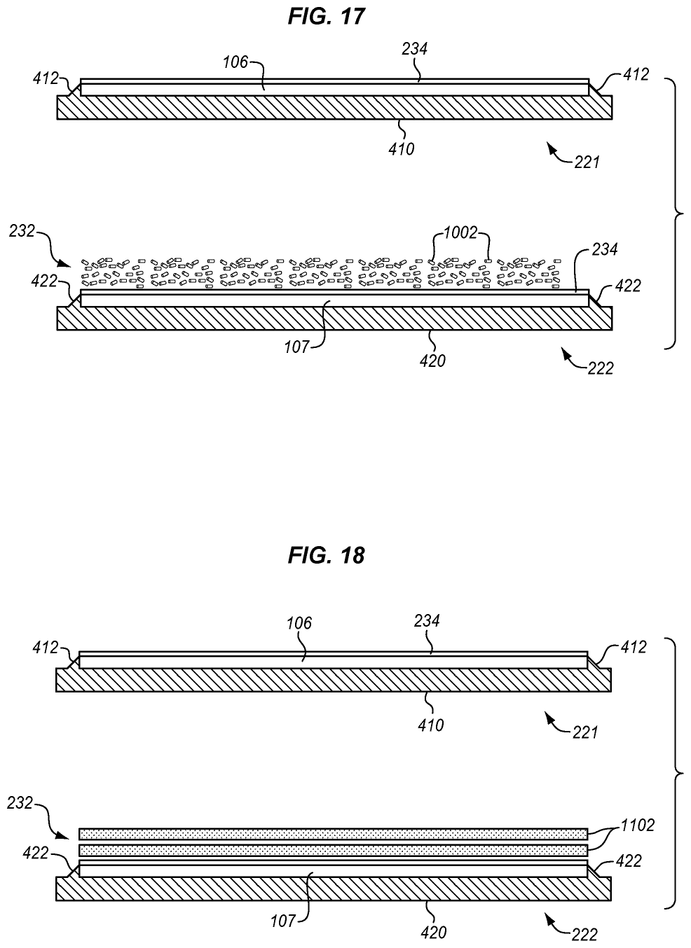

FIG. 14 is a flow chart illustrating a method 1400 of fabricating a sandwich panel 102 in another illustrative embodiment. In this embodiment, skin 106 is placed on tool member 221, and skin 107 is placed on tool member 222 (step 1402). FIG. 15 is a side view of skins 106-107 placed on tool members 221-222 in an illustrative embodiment. In FIG. 14, an adhesive 234 may be applied on the faces 416-417 of skins 106-107 (optional step 1404), such as with applicator 230. FIG. 16 is a side view of an adhesive 234 applied to skins 106-107 in an illustrative embodiment. In FIG. 14, a foamable material 232 is loaded, laid, deposited, or otherwise placed on skin 107 (step 1406). FIGS. 17-18 are side views of a foamable material 232 loaded onto skin 107 in illustrative embodiments. As shown in FIG. 17, the foamable material 232 may be comprised of foamable pellets 1002 that are loaded onto skin 107 (see optional step 1420 in FIG. 14). As shown in FIG. 18, the foamable material 232 may be comprised of one or more foamable sheets 1102 that are loaded onto skin 107 (see optional step 1422 in FIG. 14). In either case, the foamable pellets 1002 or foamable sheets 1102 may be generally distributed uniformly on skin 107 to form a consistent foam core 104.

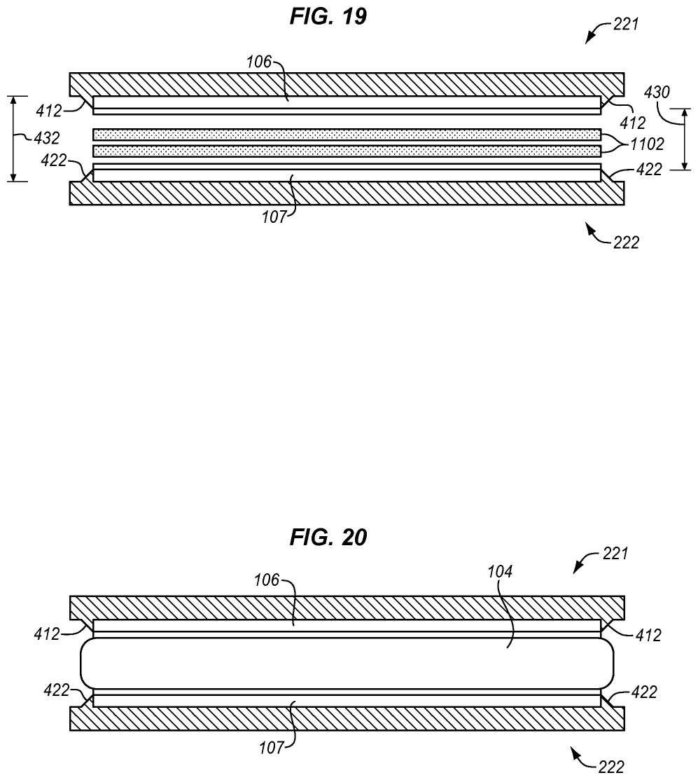

In FIG. 14, skin 106 and skin 107 are held with a gap between opposing faces of skin 106 and skin 107 (step 302). FIG. 19 is a side view of tool members 221-222 securing skins 106-107 in an illustrative embodiment. One or both of tool members 221-222 may re-orient skins 106-107 so that there is a gap 430 between opposing faces 416-417 of skins 106-107. Gap 430 is set at the desired thickness of the foam core 104 of sandwich panel 102. Thus, the overall thickness 432 of the final sandwich panel 102 is constrained by tool members 221-222.

With skins 106-107 oriented in this manner and the foamable material 232 (in its unexpanded state) arranged between skins 106-107, the foamable material 232 expands between skins 106-107 (step 304 of FIG. 14). In one embodiment, the foamable material 232 may be activated by heat (optional step 1424) with an oven 242, an autoclave 244, or another heat source to cause expansion. FIG. 20 is a side view of the foamable material 232 expanded to form the foam core 104 in an illustrative embodiment. Through expansion, the foamable material 232 spans the gap 430 between skins 106-107 and bonds to the face 416 of skin 106 and the face 417 of skin 107. Therefore, the expanded foamable material 232 forms the foam core 104 of sandwich panel 102.

After forming the foam core 104, sandwich panel 102 may be cooled (if heating was used) and removed from forming tool 220. FIG. 13 illustrates sandwich panel 102 removed from forming tool 220 in an illustrative embodiment. At this point, some excess portions 1302 of the foam core 104 may project outward from ends of skins 106-107. Thus, the excess portions 1302 of the foam core 104 may be trimmed or cut (step 1408 of FIG. 14), such was with cutting device 250. Also, sandwich panel 102 may be cut to a desired shape and/or size in step 1408. Method 1400 therefore forms sandwich panel 102, such as shown in FIG. 6.

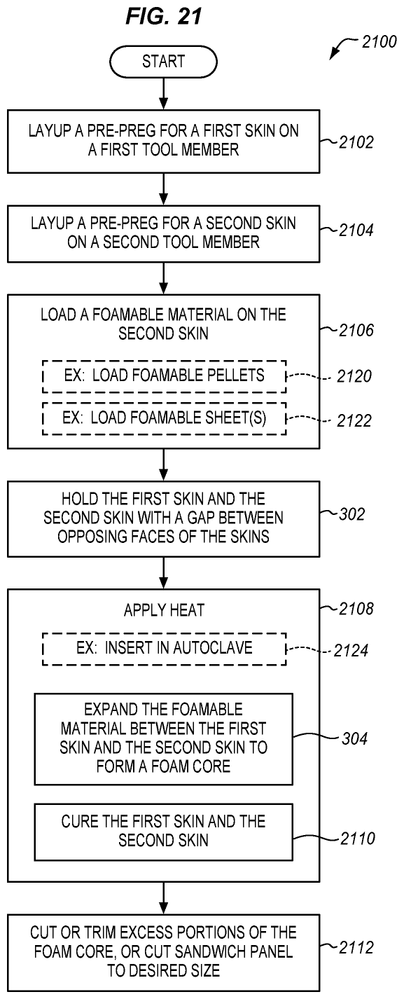

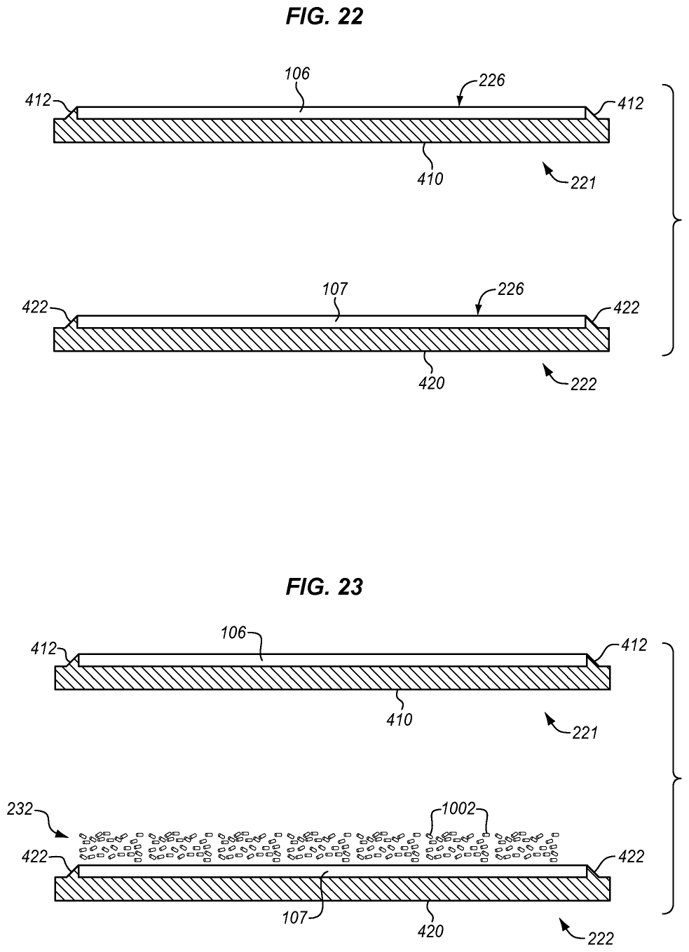

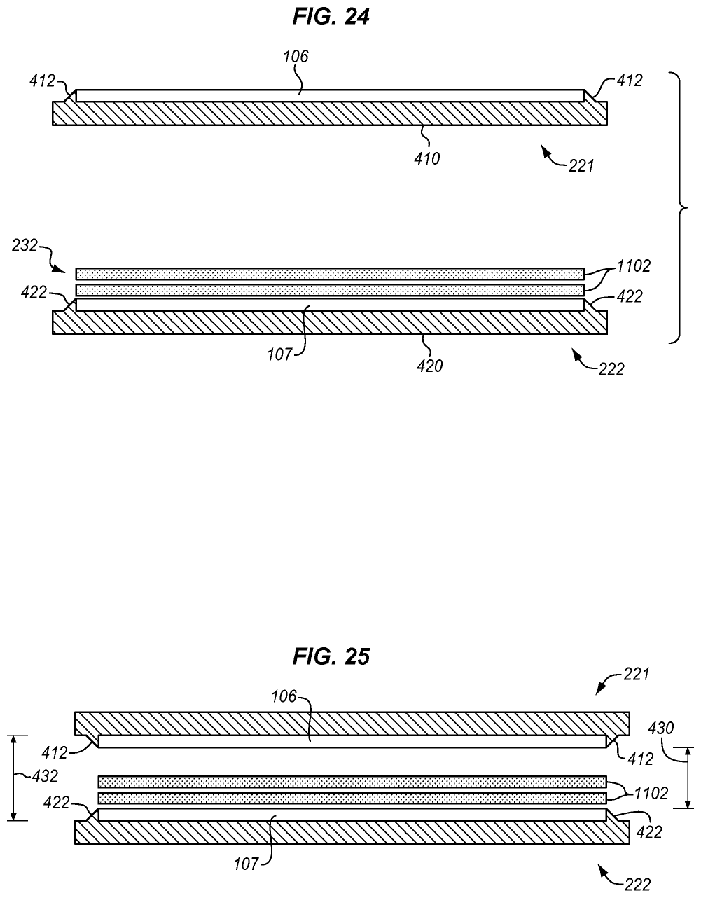

FIG. 21 is a flow chart illustrating another method 2100 of fabricating a sandwich panel 102 in an illustrative embodiment. In this embodiment, skins 106-107 are formed from a pre-preg 226, which is not yet cured and is not rigid. As a reminder, a pre-preg 226 is composite fibers that are impregnated with a resin but not yet cured. For method 2100, a pre-preg 226 for skin 106 is laid up on tool member 221 (step 2102), and a pre-preg 226 for skin 107 is laid up on tool member 222 (step 2104). FIG. 22 is a side view of skins 106-107 laid up on tool members 221-222 in an illustrative embodiment. In FIG. 21, a foamable material 232 is loaded, laid, deposited, or otherwise placed on skin 107 (step 2106). FIGS. 23-24 are side views of a foamable material 232 loaded onto skin 107 in illustrative embodiments. As shown in FIG. 23, the foamable material 232 may be comprised of foamable pellets 1002 that are loaded onto skin 107 (see optional step 2120 in FIG. 21). As shown in FIG. 24, the foamable material 232 may be comprised of one or more foamable sheets 1102 that are loaded onto skin 107 (see optional step 2122 in FIG. 21). In either case, the foamable pellets 1002 or foamable sheets 1102 may be generally distributed uniformly on skin 107 to form a consistent foam core 104.

In FIG. 21, skin 106 and skin 107 are held with a gap between opposing faces of skin 106 and skin 107 (step 302). FIG. 25 is a side view of tool members 221-222 securing skins 106-107 in an illustrative embodiment. One or both of tool members 221-222 may re-orient skins 106-107 so that there is a gap 430 between opposing faces 416-417 of skins 106-107. Gap 430 is set at the desired thickness of the foam core 104 of sandwich panel 102. Thus, the overall thickness 432 of the final sandwich panel 102 is constrained by tool members 221-222.

With skins 106-107 oriented in this manner and the foamable material 232 (in its unexpanded state) arranged between skins 106-107, heat is applied to skins 106-107 and the foamable material 232 (step 2108). For example, forming tool 220 may be inserted in an autoclave 244 (optional step 2124), where heat and pressure are applied. In another example, forming tool 220 may be inserted in an oven 242, surrounded by a heat blanket, heated internally (e.g., induction heating), etc. The applied heat activates the foamable material 232, which causes expansion of the foamable material 232 between skins 106-107 (step 304 of FIG. 21). FIG. 26 is a side view of the foamable material 232 expanded to form the foam core 104 in an illustrative embodiment. Through expansion, the foamable material 232 spans the gap 430 between skins 106-107. In FIG. 21, the applied heat also cures skins 106-107 (step 2110). It is noted that curing of skins 106-107 may further include applying pressure with autoclave 244, with vacuum-bagging, or the like. The applied heat therefore simultaneously forms the foam core 104 and cures the skins 106-107 of sandwich panel 102. The curing process also acts to bond the foam core 104 to skins 106-107.

After expansion and cure, sandwich panel 102 may be cooled and removed from forming tool 220. FIG. 13 illustrates sandwich panel 102 removed from forming tool 220 in an illustrative embodiment. At this point, some excess portions 1302 of the foam core 104 may project outward from ends of skins 106-107. Thus, the excess portions 1302 of the foam core 104 may be trimmed or cut (step 2112 of FIG. 21), such was with cutting device 250. Also, sandwich panel 102 may be cut to a desired shape and/or size in step 2112. Method 2100 therefore forms sandwich panel 102, such as shown in FIG. 6.

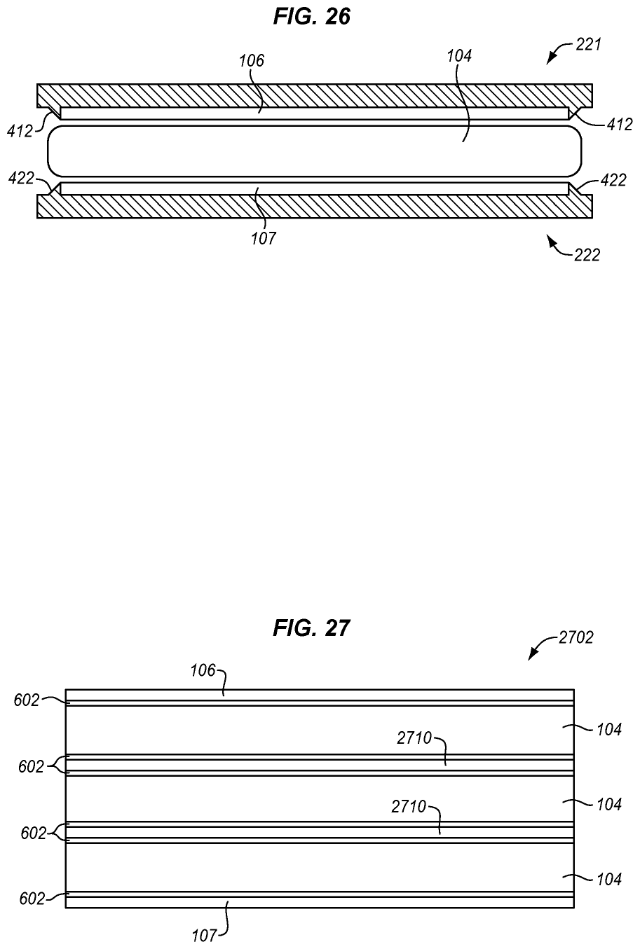

In the above embodiments, interlayers or septums may be placed in the foam core 104. FIG. 27 is a side view of a sandwich panel 2702 with interlayers 2710 in an illustrative embodiment. As above, sandwich panel 2702 includes skins 106-107. Sandwich panel 2702 also includes one or more interlayers 2710 that are generally parallel with skins 106-107, and a foam core 104 is disposed between skins 106-107 and interlayers 2710. The methods described above may be used to form sandwich panel 2702 as shown in FIG. 27. For example, tool members 221-222 may hold skins 106-107 and one or more interlayers 2710 in parallel, and activate a foamable material 232 between skins 106-107 and/or interlayers 2710 to form the foam cores 104.

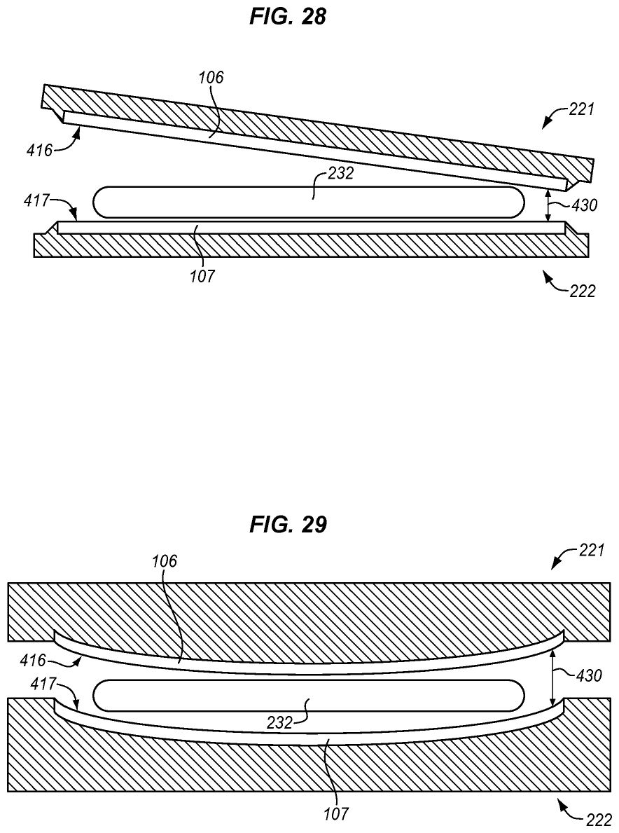

In the above embodiments, tool members 221-222 are shown as generally holding skins 106-107 in parallel with the face 416 of skin 106 facing toward face 417 of skin 107 (see, for example, FIG. 4). However, tool members 221-222 may hold skins 106-107 in other orientations. FIG. 28 is a side view of tool members 221-222 securing skins 106-107 in an illustrative embodiment. In this embodiment, tool members 221-222 hold skins 106-107 so that the face 416 of skin 106 is out-of-plane with, or is ramped with respect to, face 417 of skin 107. There is a gap 430 between skins 106-107 where the foamable material 232 is inserted. In this embodiment, the width of gap 430 varies between skins 106-107. With skins 106-107 held in this manner, the foamable material 232 is expanded between skin 106 and skin 107 to form the foam core 104 of the sandwich panel 102.

Also in the above embodiments, tool members 221-222 and skins 106-107 are shown as being generally flat. However, tool members 221-222 and skins 106-107 may have curved, domed, or other complex shapes. FIG. 29 is a side view of tool members 221-222 securing skins 106-107 in an illustrative embodiment. In this embodiment, tool members 221-222 are curved, and hold skins 106-107 that are also curved. The face 416 of skin 106 is facing toward face 417 of skin 107, with a gap 430 between skins 106-107. The foamable material 232 is inserted between skins 106-107, and is expanded between skin 106 and skin 107 to form the foam core 104 of the sandwich panel 102. Although a curved shape is shown in FIG. 29, other complex shapes of skins 106-107 and tool members 221-222 are considered herein.

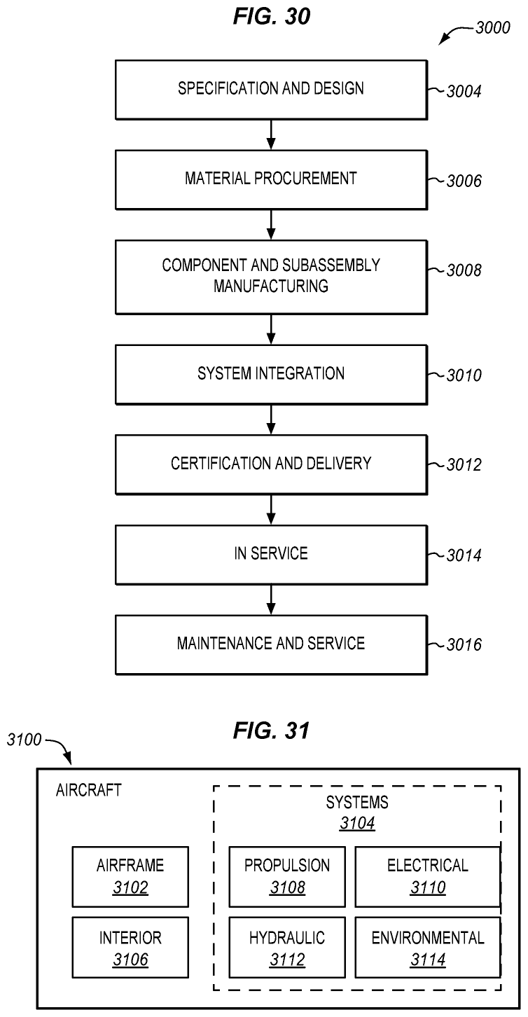

The embodiments of the disclosure may be described in the context of an aircraft manufacturing and service method 3000 as shown in FIG. 30 and an aircraft 3100 as shown in FIG. 31. During pre-production, exemplary method 3000 may include specification and design 3004 of aircraft 3100, and material procurement 3006. During production, component and subassembly manufacturing 3008 and system integration 3010 of aircraft 3100 takes place. Thereafter, aircraft 3100 may go through certification and delivery 3012 in order to be placed in service 3014. While in service by a customer, aircraft 3100 is scheduled for routine maintenance and service 3016 (which may also include modification, reconfiguration, refurbishment, and so on).

Each of the processes of method 3000 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 31, aircraft 3100 produced by exemplary method 3000 may include an airframe 3102 with a plurality of systems 3104 and an interior 3106. Examples of high-level systems 3104 include one or more of a propulsion system 3108, an electrical system 3110, a hydraulic system 3112, and an environmental system 3114. Any number of other systems may be included. Although an aerospace example is shown, the principles described in this specification may be applied to other industries, such as the automotive industry.

Apparatus and methods embodied herein may be employed during any one or more of the stages of the production and service method 3000. For example, components or subassemblies corresponding to production process 3008 may be fabricated or manufactured in a manner similar to components or subassemblies produced while aircraft 3100 is in service. Also, one or more apparatus embodiments, method embodiments, or a combination thereof may be utilized during the production stages 3008 and 3010, for example, by substantially expediting assembly of or reducing the cost of aircraft 3100. Similarly, one or more of apparatus embodiments, method embodiments, or a combination thereof may be utilized while aircraft 3100 is in service, for example and without limitation, to maintenance and service 3016.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope is not limited to those specific embodiments. Rather, the scope is defined by the following claims and any equivalents thereof.

1. A method of fabricating a sandwich panel, the method comprising:
holding a first skin and a second skin of the sandwich panel with a gap between opposing faces of the first skin and the second skin; and
expanding a foamable material between the first skin and the second skin to form a foam core of the sandwich panel.

2. The method of claim 1 further comprising:
applying an adhesive on the opposing faces of the first skin and the second skin prior to expanding the foamable material.

3. The method of claim 1 further comprising:
inserting the foamable material in the gap between the first skin and the second skin.

4. The method of claim 1 further comprising:
cutting excess portions of the foam core that project from ends of the first skin and the second skin.

5. The method of claim 1 wherein expanding the foamable material comprises:
activating the foamable material with heat.

6. The method of claim 1 wherein:
the first skin and the second skin are formed from a metal material.

7. The method of claim 1 wherein:
the first skin and the second skin are formed from a cured composite material.

8. The method of claim 1 wherein:
the first skin and the second skin are formed from pre-impregnated composite fibers; and
expanding the foamable material comprises activating the foamable material with heat, wherein the heat also cures the first skin and the second skin.

9. The method of claim 1 wherein:
the foamable material comprises foamable pellets.

10. The method of claim 1 wherein:
the foamable material comprises at least one foamable sheet.

11. The method of claim 1 wherein:
the sandwich panel is manufactured for an aircraft.

12. A method of fabricating a sandwich panel, the method comprising:
laying up pre-impregnated composite fibers for a first skin of the sandwich panel on a first tool member;
laying up pre-impregnated composite fibers for a second skin of the sandwich panel on a second tool member;
loading a foamable material on the second skin;
holding the first skin and the second skin with a gap between opposing faces of the first skin and the second skin; and
applying heat to expand the foamable material between the first skin and the second skin to form a foam core of the sandwich panel, and to cure the first skin and the second skin.

13. The method of claim 12 wherein applying heat comprises:
inserting the first tool member and the second tool member in an autoclave.

14. The method of claim 12 wherein:
the foamable material comprises foamable pellets.

15. The method of claim 12 wherein:
the foamable material comprises at least one foamable sheet.

16. The method of claim 12 wherein:
the sandwich panel is manufactured for an aircraft.

17. A fabrication system configured to form a sandwich panel, the fabrication system comprising:
a forming tool having:
a first tool member configured to hold a first skin of the sandwich panel; and
a second tool member configured to hold a second skin of the sandwich panel with a gap between opposing faces of the first skin and the second skin; and
an activator configured to activate a foamable material between the first skin and the second skin to expand to form a foam core of the sandwich panel.

18. The fabrication system of claim 17 wherein:
the activator comprises an autoclave.

19. The fabrication system of claim 17 further comprising:
an applicator configured to insert the foamable material in the gap between the first skin and the second skin.

20. The fabrication system of claim 17 further comprising:
an applicator configured to apply an adhesive on the opposing faces of the first skin and the second skin prior to expanding the foamable material.
